(19) United States
(12) Patent Application Publication
(10) Pub. No.: US 2004/0244798 A1
(43) Pub. Date: Dec. 9, 2004

(54) Nasal respirator

(76) Inventor: Jung Hui Lin, Kaohsiung City (TW)

Correspondence Address: BRUCE H. TROXELL, SUITE 1404, 5205 LEESBURG PIKE, FALLS CHURCH, VA, 22041, US

(21) Appl. No.: 10/748,294

(22) Filed: Dec. 31, 2003

(30) Foreign Application Priority Data
Jun. 6, 2003 (CN) 03231913.4

(51) Int. Cl. A62B 7/10

(52) U.S. Cl. 128/206.18

(57) ABSTRACT

A nasal respirator including a nasal shade body formed of a flexible sheet. The nasal shade body includes two cover sections on two opposite sides of the nasal shade body, a loose section connected between the two cover sections and two ear string members disposed on two sides of the cover sections. The loose section is composed of an outer facial layer and an inner facial layer which together define an envelope. A filter material is implanted in the envelope for achieving a filtering effect. Multiple rigid sockets are disposed in a predetermined position of the cover sections and/or the loose section for selectively connecting the nasal shade body with a mouth shade body. When the ear string members are positioned in a specific position of the ears of a wearer, the cover sections and the loose section respectively cover the chins and nose of the wearer.

### BACKGROUND OF THE INVENTION

The present invention is related to a respirator, and more particularly to a simple respirator including a nasal shade body and a mouth shade body which can be detachably selectively connected with each other. In addition, the respirator has air-filtering effect.

Many types of respirators have been developed for shading the mouth and nose of human body from dust or pollutants in the air. For example, Taiwanese Patent No. 90101527 entitled “disposable respirator and manufacturing method thereof” discloses a typical respirator including a mouth shade sheet and ear strings disposed on two sides of the mouth shade sheet. The ear strings are made of extensible unwoven fabric material and have loops for wearing the respirator on the ears. In some other conventional respirators, elastic straps are used instead of the ear strings. The respirator disclosed by the above patent is made of one single sheet and is disposable. Therefore, such respirator is made at low cost.

Taiwanese Patent No. 90105398 entitled “semi-mask type respirator with head straps” discloses a respirator having adjustable elastic straps. When the respirator covers the nose and mouth of a wearer, a strap support is positioned on the scull of the wearer. At least two upper straps and lower straps are oppositely connected with the strap support to form an adjustable structure. In order to adjust the distance between the upper and lower straps, the strap support is equipped with an adjustment mechanism and the tipper and lower straps have integrated strap main bodies, support crowns and skull hat. Therefore, such structure is complicated.

Although the above conventional respirators can shade the nose and mouth of a user from dust or pollutants, they still have some shortcomings. For example, the conventional respirator cannot be repeatedly used. Also, the semi-mask type respirator of the Taiwanese Patent No. 90105398 can hardly fully cover the chins of a user to prevent the chins from being exposed to ultraviolet ray and avoid freckles. Moreover, in practice, when wearing the respirator, it is often found that the user can hardly clearly talk to others unless the user takes off the respirator. Under such circumstance, it is necessary to re-adjust the adjustment mechanism when the user again wears the respirator. Therefore, it should be considered whether the respirator can be easily disassembled into a nose shade body and a mouth shade body for respectively covering the nose and mouth of a user. The nose shade body and mouth shade body are detachably selectively connectable as desired.

### SUMMARY OF THE INVENTION

It is therefore a primary object of the present invention to provide a nasal respirator including a nasal shade body formed of a flexible sheet. The nasal shade body includes two cover sections on two opposite sides of the nasal shade body, a loose section connected between the two cover sections and two ear string members disposed on two sides of the cover sections. An upper fastening strap having two head ends is detachably disposed on two connecting points of the cover sections. When the ear string members are positioned in a specific position of the ears of a wearer, the cover sections and the loose section respectively cover the chins and nose of the wearer.

It is a further object of the present invention to provide the above nasal respirator further including a mouth shade body detachably connectable with a lower portion of the nasal shade body. At least one rigid socket or press hole is disposed on bottom edge of the cover sections or the loose section. At least one rigid button or stake is disposed on upper edge of the mouth shade body corresponding to the socket or press hole. When the button or stake is pressed into the socket or press hole, the mouth shade body and the nasal shade body are integrally detachably connected to cover the nose and mouth of the user. The mouth shade body can be detached from the nasal shade body so as not to affect the user's talking.

It is still a further object of the present invention to provide the above nasal respirator in which the loose section is composed of multiple separated layers including an outer facial layer and an inner facial layer. The inner and outer facial layers together define therebetween an envelope. A filter material or the like can be implanted in the envelope for enhancing the filtering effect of the respirator.

It is still a further object of the present invention to provide the above nasal respirator in which a bottom side of the mouth shade body is formed with an exposed or hidden open lined layer for a lower fastening strap to pass therethrough. The lower fastening strap has two ends extending out of the open lined layer. Two attachable sections are disposed on inner faces of the two ends for connecting the lower fastening strap with specific portions of the upper fastening strap.

The present invention can be best understood through the following description and accompanying drawings wherein:

### BRIEF DESCRIPTION OF THE DRAWINGS

FIG. 1 is a perspective view of the nasal shade body of the present invention;

FIG. 2 is a sectional view according to FIG. 1, showing the structure of the loose section of the nasal shade body of the present invention;

FIG. 3 is a perspective view showing that a user wears the nasal shade body of the present invention on his face;

FIG. 4 is a perspective view of the assembly of the nasal shade body and mouth shade body of the present invention;

FIG. 5 is a longitudinal sectional view according to FIG. 4, showing the structure of the mouth shade body of the present invention; and

FIG. 6 is a perspective view showing that a user wears the assembly of the nasal shade body and mouth shade body of the present invention on his face.

### DETAILED DESCRIPTION OF THE PREFERRED EMBODIMENTS

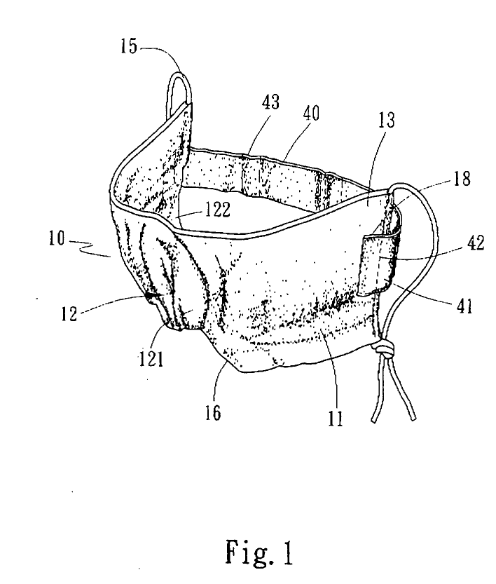

Please refer to FIGS. 1 to 4. The nasal respirator of the present invention includes a nasal shade body 10 which is formed of a substantially rectangular flexible sheet. The nasal shade body 10 includes two cover sections 11 on two opposite sides of the nasal shade body 10 and a loose section 12 connected between the two cover sections 11. In a preferred embodiment, the loose section 12 and the cover sections 11 are connected by means of stitching. In addition, the flexibility of the loose section 12 is greater than that of the cover sections 11. When a user wears the nasal shade body 10, the loose section 12 can be deformed or extended to a larger extent.

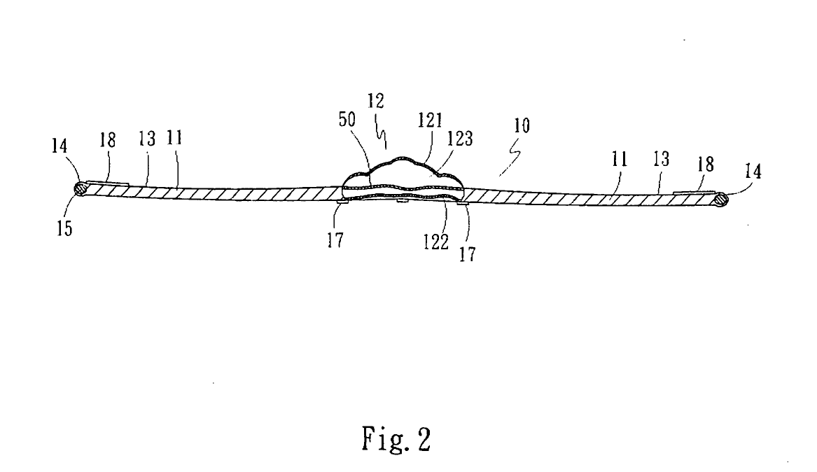

Referring to FIG. 2, the loose section 12 is composed of multiple separated layers including an outer facial layer 121 and an inner facial layer 122. The inner and outer facial layers 122, 121 together define therebetween an envelope 123. A filter material 50 or the like can be filled or implanted in the envelope 123, whereby the loose section 12 can achieve an air or dust-filtering effect. The edge 13 of each of the cover sect ions 11 is formed with a vertical cut or passage 14. The passage 14 can be formed by means of reversely crimping the edge 13 into a U-shape and stitching the edge 13. Alternatively, the edge 13 can be directly cut to form the cut 14. An ear string member 15 can be conducted through the cut or passage 14.

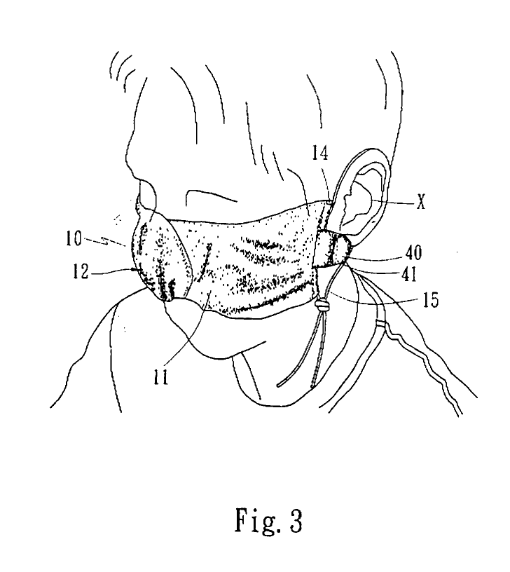

Referring to FIG. 3, when the ear string member 15 is positioned on a specific portion of the ear X of a wearer, the loose section 12 covers the nose of the wearer and the cover sections 11 extend to the ear X of the wearer to cover the chins of the wearer. The cover sections 11 serve to prevent the chins of the wearer from being exposed to ultraviolet ray and having freckles. The bottom edge 16 of the cover section 11 near the loose section 12 has an oblique arched profile corresponding to the profile of the chin of the wearer. This makes the cover sections 11 more snugly attach to the chins of the wearer.

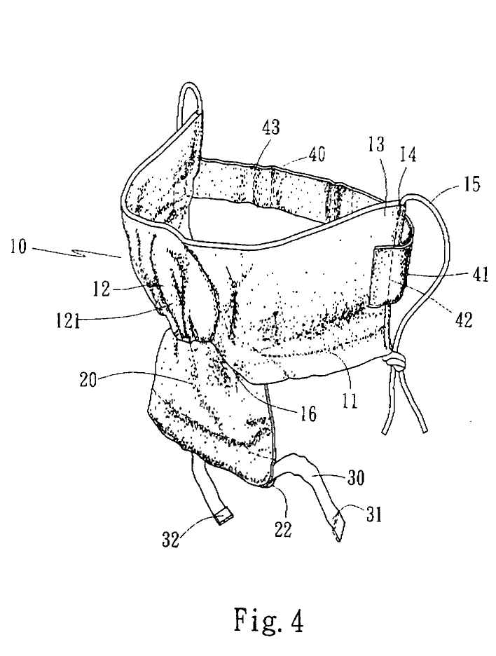

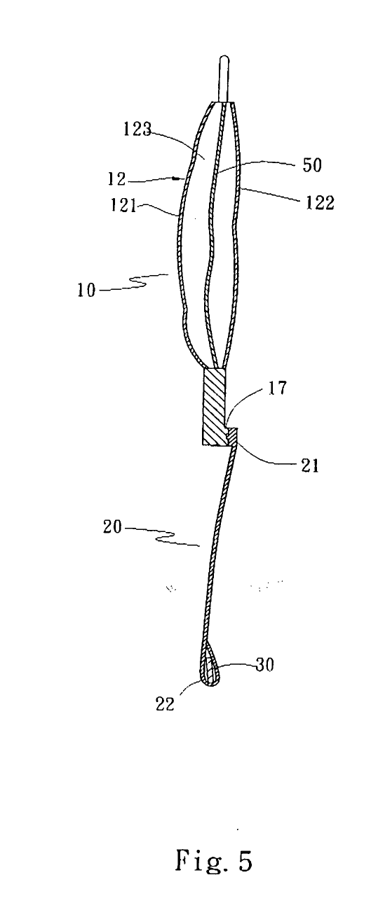

Referring to FIGS. 4 and 5, at least one rigid socket or press hole 17 is disposed under a predetermined portion of the cover sections 11 and the loose section 12. By means of the socket or press hole 17, a user can selectively connect the nasal shade body 10 with a mouth shade body 20. The mouth shade body 20 is formed of a flexible sheet. Several rigid buttons or stakes 21 are disposed on upper side of the mouth shade body 20 corresponding to the socket or press hole 17. When the buttons or stakes 21 are pressed into the socket or press hole 17, the mouth shade body 20 and the nasal shade body 10 are integrally detachably connected to cover the nose and mouth of the user.

The bottom side of the mouth shade body 20 is formed with an exposed or hidden open lined layer 22. In a preferred embodiment, the lined layer 22 is formed in such a manner that the bottom edge of the mouth shade body 20 is inward folded and stitched to form a tunnel having two openings at two ends. A lower fastening strap 30 is conducted through the tunnel. The lower fastening strap 30 is preferably an elastic strap. The lower elastic strap 30 has two ends 31 extending out of the open lined layer 22. Two attachable sections 32 are disposed on inner faces of the two ends 31. In a preferred embodiment, an tipper elastic strap 40 is disposed in a predetermined position of the nasal shade body 10. The upper elastic strap 40 has two head ends 41 and two attachable faces 42 disposed on inner sides of the head ends 41. In principle, attachable sections 18 are disposed on two sides 13 of the nasal shade body 10. The attachable faces 42 of the upper elastic strap 40 are respectively attached to the attachable sections 18, whereby the upper elastic strap 40 can form a loop. At least one attachable section 43 is disposed in a predetermined position of the other side of the upper elastic strap 40 opposite to the inner attachable face 42. The attachable section 32 of the lower elastic strap 30 is attached to the attachable section 43 to fix the mouth shade body 20 in a specific position.

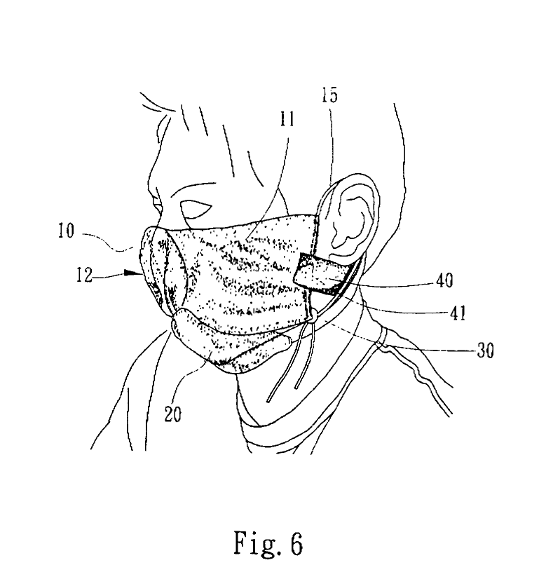

Referring to FIG. 6, when a user wears the nasal shade body 10 on his/her nose and chins, the mouth shade body 20 can cover the mouth of the user by means of attaching the attachable section 32 of the lower elastic strap 30 to the attachable face 42 of the upper attachable strap 40.

According to the above arrangement, the nasal respirator of the present invention has the following characteristics and advantages:

1. The lower part of the nasal shade body 10 is removed to form the oblique arched bottom edge 16 of the nasal shade body 10 corresponding to the configuration or profile of human chins. Therefore, the cover sections 11 can more snugly attach to the chins of a wearer.

2. The removed material is repositioned on two sides of the cover sections 11, whereby the nasal shade body 10 has a substantially rectangular configuration for covering the chins of the user. Therefore, the nasal shade body 10 serves to shade the chins from ultraviolet ray.

3. The loose section 12 of the nasal shade body 10 can be flexed or deformed to a relative large extent so that the loose section 12 can more effectively cover the nose of a user. Moreover, the loose section 12 is composed of the outer facial layer 121 and an inner facial layer 122 which together define the envelope 123. The filter material 50 or the like is implanted in the envelope 123 to achieve a better protective or filtering effect than the prior art.

4. The rigid socket or press hole 17 is disposed in a predetermined position of lower side of the nasal shade body 10. Several rigid buttons or stakes 21 are disposed on upper side of the mouth shade body 20 corresponding to the socket or press hole 17. The buttons or stakes 21 can be pressed into the socket or press hole 17 to selectively detachably connect the mouth shade body 20 with the nasal shade body 10. Therefore, the nasal respirator can be more elastically and widely used. Moreover, when talking to someone else, the user can take off the mouth shade body 20 to more clearly speak.

5. The bottom side of the mouth shade body 20 is formed with the open lined layer 22. The lower elastic strap 30 is conducted through the liner layer 22. The upper and lower elastic straps, 40, 30 have attachable faces and sections 42, 43, 32. Therefore, a user can adjust the tightness of the straps according to the configuration of his/her head. In addition, the user can easily assemble or take off the nasal respirator.

The above embodiments are only used to illustrate the present invention, not intended to limit the scope thereof. Many modifications of the above embodiments can be made without departing from the spirit of the present invention.

What is claimed is:

1. A nasal respirator comprising a nasal shade body which is formed of a flexible sheet, the nasal shade body including:
two cover sections on two opposite sides of the nasal shade body;
a loose section connected between the two cover sections; and
two ear string members disposed on two sides of the cover sections, whereby when the ear string members are positioned in a specific position of the ears of a wearer, the cover sections and the loose section respectively cover the chins and nose of the wearer.

2. The nasal respirator as claimed in claim 1, wherein the loose section is composed of multiple separated layers including an outer facial layer and an inner facial layer, the inner and outer facial layers together defining therebetween an envelope, whereby a filter material or the like can be implanted or filled in the envelope.

3. The nasal respirator as claimed in claim 1, wherein the loose section of the nasal shade body has a flexibility greater than that of the cover sections.

4. The nasal respirator as claimed in claim 1, wherein an edge of each of the cover sections is formed with a vertical cut or passage, whereby the ear string member can be conducted through the cut or passage.

5. The nasal respirator as claimed in claim 1, wherein a bottom edge of the cover section near the loose section has an oblique arched profile.

6. The nasal respirator as claimed in claim 1, further comprising a mouth shade body which is formed of a flexible sheet, the mouth shade body being connectable with a lower portion of the cover sections or loose section of the nasal shade body.

7. The nasal respirator as claimed in claim 6, wherein at least one rigid socket or press hole is disposed in a predetermined position of a lower portion of the cover sections and/or the loose section, whereby by means of the socket or press hole, a user can selectively connect the nasal shade body with the mouth shade body, several rigid buttons or stakes being disposed on the mouth shade body corresponding to the socket or press hole, whereby when the buttons or stakes are pressed into the socket or press hole, the mouth shade body and the nasal shade body are integrally detachably connected to cover the nose and mouth of the user.

8. The nasal respirator as claimed in claim 6, wherein a bottom side of the mouth shade body is formed with an exposed or hidden open lined layer for a lower fastening strap to pass therethrough.

9. The nasal respirator as claimed in claim 8, wherein the lower fastening strap is made of an elastic strap and has two ends extending out of the open lined layer, two attachable sections being disposed on inner faces of the two ends, an upper fastening strap being disposed on the nasal shade body, the upper fastening strap having two head ends, two attachable faces being disposed on inner sides of the head ends, at least one attachable section being disposed on the other side of the upper elastic strap opposite to the inner attachable face, the attachable section of the lower fastening strap being attachable to the attachable section of the upper fastening strap to fix the lower fastening strap on the upper fastening strap, the attachable faces of the upper fastening strap being respectively attachable to two attachable sections disposed on two sides of the nasal shade body.
